(19) United States
(12) Patent Application Publication
(10) Pub. No.: US 2022/0025151 A1
(43) Pub. Date: Jan. 27, 2022

(54) Composition of Styrenic Polymers Derived Through Depolymerization of Polystyrene

(71) Applicant: GreenMantra Recycling Technologies Ltd., Brantford (CA)

(72) Inventors: Domenic Di Mondo, Brampton (CA); Benjamin Scott, Guelph (CA)

(21) Appl. No.: 17/493,162

(22) Filed: Oct. 4, 2021

Related U.S. Application Data
(63) Continuation of application No. PCT/CA2020/050439, filed on Apr. 2, 2020.
(60) Provisional application No. 62/829,482, filed on Apr. 4, 2019.

(51) Int. Cl. C08J 11/04; C08K 3/08

(52) U.S. Cl. CPC C08J 11/04; C08K 3/08; C08J 2325/06; C08K 2003/0881; C08K 2003/0893; C08K 2003/0856

(57) ABSTRACT

Styrenic polymers created via the depolymerization of a polystyrene feedstock. In some embodiments the polystyrene feedstock contains recycled polystyrene. In some embodiments, the styrenic polymers contain olefins, iron, titanium, and/or zinc.

### CROSS-REFERENCE TO RELATED APPLICATION

This application is a continuation of International Application No. PCT/CA2020/050439 having an international filing date of Apr. 2, 2020, entitled “Composition of Styrenic Polymers Derived Through Depolymerization of Polystyrene”. The '439 application is related to and claims priority benefits from U.S. provisional patent application Ser. No. 62/829,482 filed on Apr. 4, 2019, entitled “Composition of Styrenic Polymers Derived Through Depolymerization of Polystyrene”.

The '439 and '482 applications are hereby incorporated by reference herein in their entireties.

### FIELD OF THE INVENTION

The invention relates to styrenic polymers derived through the depolymerization of polystyrene.

Polystyrene is among the fastest growing solid waste. Further polystyrene is non-biodegradable, leading to its accumulation in nature. The vast majority of polystyrene waste in general is either land-filled or burnt. The former leads to the loss of material and waste of land, while the latter results in emission of green-house-gases. Only a small proportion of polystyrene waste is currently being recycled (at a rate less than 5% in North America and Europe) as secondary polymers, which have poor quality and give low financial returns.

In recent times, there have been considerable efforts to convert polystyrene wastes into useful products such as organic solvents, and back to the monomer styrene, often through thermal degradation. Existing conversion processes are not efficient and can release green-house gases and/or volatile aromatic compounds into the environment. Further, current techniques can be sensitive to the quality and quantity of polystyrene feed which can have an impact on the end product quality. This is especially troublesome as polystyrene sources can vary in their consistency due to the varying plastic grades and applications.

It would be advantageous to employ readily available polystyrene waste as the feedstock for conversion into higher value specialty chemicals, but not limited to, styrenic polymers, macromonomers, solvents, and polymer precursors. Employing this solid waste to produce useful specialty chemicals would address growing disposal problems.

It would also be advantageous to have a relatively inexpensive process for producing specialty chemicals, such as macromonomers, solvents, and polymer precursors. Such a process would ideally employ a readily available inexpensive feedstock and use an inexpensive process.

### SUMMARY OF THE INVENTION

A styrenic polymer created via depolymerization of a polystyrene feedstock.

In some embodiments, the composition includes at least about 90% by weight of a styrenic polymer with molecular weight between 1,000-200,000 amu wherein the styrenic polymer was derived from depolymerization of polystyrene plastic feedstock.

In some embodiments, the depolymerization of the polystyrene plastic feedstock is at least partially catalytic. In some embodiments, the depolymerization of the polystyrene plastic feedstock is at least partially thermal.

In some embodiments, the polystyrene feedstock comprises post-consumer recycle derived reclaimed polystyrene. In some embodiments, the polystyrene feedstock comprises post-industrial recycle derived reclaimed polystyrene. In some embodiments, the polystyrene feedstock comprises greater than 5% of post-consumer recycle derived reclaimed polystyrene.

In some embodiments, the styrenic polymer comprises between 0.1-5% olefin content on the backbone of the chain.

In some embodiments, the styrenic polymer comprises greater than 50 ppm of zinc; greater than 20 ppm titanium; and/or greater than 20 ppm iron.

In some embodiments, the styrenic polymer has an average molecular weight between 10,000 amu and 150,000 amu and a glass transition temperature between 59° C. and 92° C.

In some embodiments, the styrenic polymer comprises a grafted acid, such as maleic anhydride. In some embodiments, the composition is soluble in organic mediums and/or aqueous formulations.

In some embodiments, the polystyrene feedstock comprises up to 25% of material that is other than polystyrene material, based on the total weight of said polystyrene feedstock.

### BRIEF DESCRIPTION OF THE DRAWINGS

FIG. 1 is a flowchart illustrating a process for treating polystyrene material to create styrenic polymers.

FIG. 2 is an overlay of a series of Differential Scanning calorimetry (DSC) thermograms of various styrenic polymers produced via depolymerization of polystyrene.

FIG. 3 is a ¹H Nuclear Magnetic Resonance (NMR) spectra of styrenic polymers produced via depolymerization.

FIG. 4 is an enlarged version of section A of FIG. 3 showing the peaks corresponding to the presence of olefins.

FIG. 5 is a Differential Scanning calorimetry thermogram for a styrenic polymer produced via depolymerization of polystyrene.

FIG. 6 is a Differential Scanning calorimetry thermogram showing specific heat data for a styrenic polymer produced via depolymerization of polystyrene.

FIG. 7 is a Gel Permeation Chromatogram of a styrenic polymer produced via depolymerization of polystyrene.

FIG. 8 is a Nuclear Magnetic Resonance (NMR) spectra of a styrenic polymer produced via depolymerization.

FIG. 9 is an enlarged version of section B of FIG. 8 showing the peaks corresponding to the presence of olefins.

FIG. 10 is a ¹³C NMR spectra of a styrenic polymer produced via depolymerization.

FIG. 11 is a ¹³C NMR spectra of a styrenic polymer produced via depolymerization.

FIG. 12 is a Thermogravimetric Analysis thermogram showing weight loss as a function of temperature for a styrenic polymer produced via depolymerization of polystyrene.

### DETAILED DESCRIPTION OF ILLUSTRATIVE EMBODIMENT(S)

Processes and systems for converting polystyrene material into styrenic polymers is discussed in International Application PCT/CA2017/051166 which is hereby incorporated by reference. An abbreviated description of treating polystyrene material, such as waste polystyrene material, within a reactor of a system is provided below.

Suitable waste polystyrene material includes, but it not limited to, expanded, and/or extruded polystyrene foam, and/or rigid products. In some embodiments, the polystyrene feedstock comprises recycled polystyrene and/or virgin polystyrene.

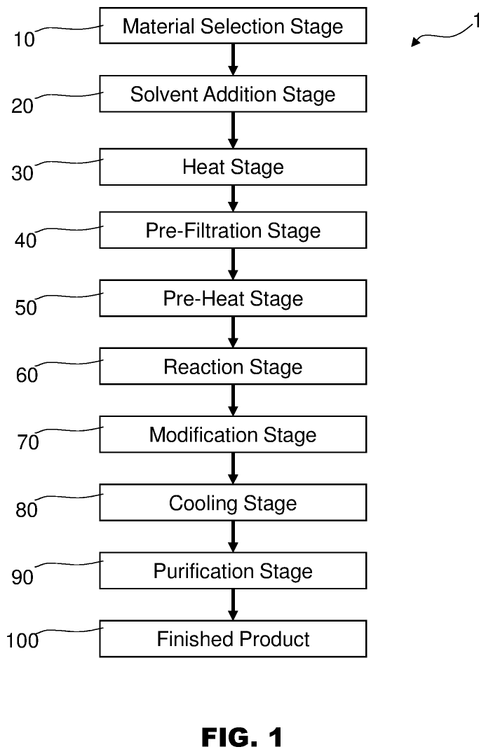

FIG. 1 illustrates Process 1 for treating polystyrene material. Process 1 can be run in batches or a continuous process. The parameters of Process 1, including but not limited to temperature, flow rate of polystyrene, monomers/copolymers grafted during the reaction and/or modification stages, and total number of pre-heat, reaction, or cooling segments, can be modified to create end products of varying molecular weights, such as macromonomers, or polyaromatic products. For example, raising the temperature and/or decreasing the flow rate through the reaction sections or changing the number of reaction sections will result in the product of a lower molecular weight. In some embodiments, the styrenic polymers have varying molecular weights between 1,000-200,000 amu. In some more preferred embodiments, the styrenic polymers have varying molecular weights between 50,000-150,000 amu. In some even more preferred embodiments, the styrenic polymers have varying molecular weights between 55,000-120,000 amu.

In Material Selection Stage 10, polystyrene feed is sorted/selected and/or prepared for treatment. In some embodiments, the feed can contain up to 25% polyolefins, PET, EVA, EVOH, and lower levels of undesirable additives or polymers, such as nylon, rubber, PVC, ash, filler, pigments, stabilizers, grit, or other unknown particles.

In some embodiments, the polystyrene material feed includes waste polystyrene material feed. Suitable waste polystyrene material feeds include mixed polystyrene waste such as expanded or extruded foam, and ridged products. e.g., foam food containers, or packaging products. The mixed polystyrene waste can include various melt flows and molecular weights. In some embodiments, the waste polystyrene material feed includes up to 25% of material that is other than polystyrene material, based on the total weight of the waste polystyrene material feed.

In certain embodiments, the solid polystyrene material is a recycled polystyrene. In some embodiments, the recycled polystyrene is a pellet made from recycled polystyrene foam and/or rigid polystyrene. Suitable waste polystyrene material includes, but is not limited to, mixed polystyrene waste such as expanded, and/or extruded polystyrene foam, and/or rigid products. For example, foam food containers, or packaging products. The mixed polystyrene waste can include various melt flows and molecular weights. In some embodiments, the waste polystyrene material feed includes up to 25% of material that is other than polystyrene material, based on the total weight of the waste polystyrene material feed.

In some embodiments, the polystyrene feed has an average molecular weight between 150,000 amu and 500,000 amu. In some of these embodiments, the polystyrene feed has an average molecular weight between 200,000 amu and 250,000 amu.

In some embodiments, the material selected in Material Selection Stage 10 comprises recycled polystyrene. In other or the same embodiments, the material selected in Material Selection Stage 10 comprises any one of, or combinations of, post-industrial and/or post-consumer waste polystyrene, recycled polystyrene, and/or virgin polystyrene. In some embodiments, the polystyrene material feed includes primary virgin granules of polystyrene. The virgin granules can include various molecular weights and melt flows. In some embodiments, the recycled polystyrene is a pellet made from recycled polystyrene foam and/or rigid polystyrene.

In optional Solvent Addition Stage 20, the polystyrene material can be dissolved in certain solvents prior to depolymerization to adjust the viscosity of the polymer at various temperatures. In some embodiments, solvents, such as toluene, xylenes, cymenes, or terpinenes, are used to dissolve the polystyrene before it undergoes depolymerization within the reactor bed/vessels. In certain embodiments, the desired product can be isolated via separation or extraction and the solvent can be recycled.

In some embodiments, the material selected in Material Selection Stage 10 can be heated in Heat Stage 30 in an extruder and undergoes Pre-Filtration Process 40. In some embodiments, the extruder is used to increase the temperature and/or pressure of the incoming polystyrene and is used to control the flow rates of the polystyrene. In some embodiments, the extruder is complimented by or replaced entirely by a pump/heater exchanger combination. In some embodiments, the material enters a molten state.

Pre-Filtration Process 40 can employ both screen changers and filter beds, along with other filtering techniques/devices to remove contaminants from and purify the heated material. The resulting filtered material is then moved into an optional Pre-Heat Stage 50 which brings the filtered material to a higher temperature before it enters Reaction Stage 60. Pre-Heat Stage 50 can employ, among other devices and techniques, static and/or dynamic mixers and heat exchangers such as internal fins and heat pipes.

Material in Reaction Stage 60 undergoes depolymerization. This depolymerization can be a purely thermal reaction and/or it can employ catalysts. Depending on the starting material and the desired styrenic polymer latex, depolymerization might be used for a slight or extreme reduction of the molecular weight of the starting material. In some embodiments, the catalyst used is a zeolite or alumina supported system or a combination of the two. In some embodiments, the catalyst is [Fe—Cu—Mo—P]/Al₂O₃. In some embodiments, the catalyst is prepared by binding a ferrous-copper complex to an alumina or zeolite support and reacting it with an acid comprising metals and non-metals to obtain the catalyst material. Other suitable catalyst materials include zeolite, mesoporous silica, H-mordenite and alumina. The system can also be run in the absence of a catalyst and produce lower molecular weight polymer through thermal degradation/depolymerization. In some embodiments the depolymerization process utilizes a catalyst such as [Fe—Cu—Mo—P]/Al₂O₃, zeolite, or other alumina supported systems, and/or thermal depolymerization. In some embodiments, the catalyst can be contained in a permeable container. In some embodiments, the catalyst can contain, iron, copper, molybdenum, phosphorous, and/or alumina.

In some embodiments, the depolymerization of the polymeric material is a catalytic process, a thermal process, utilizes free radical initiators, and/or utilizes radiation.

Reaction Stage 60 can employ a variety of techniques/devices including, among other things, fixed beds, horizontal and/or vertical reactors, and/or static mixers. In some embodiments, Reaction Stage 60 employs multiple reactors and/or reactors divided into multiple sections. In certain embodiments, the reactor(s) contains spacer tube(s), static mixer(s) and/or annular insert(s). In certain embodiments, the static mixer(s) and/or annular insert(s) are removable. In some embodiments, multiple reactors are connected in series and/or stacked.

After Reaction Stage 60 the depolymerized material enters optional Modification Stage 70. Modification Stage 70 involves grafting various monomers and/or copolymers such as, but not limited to, acids, alcohols, acetates, and alkenes such as hexene onto the depolymerized product.

Cooling Stage 80 can employ heat exchangers, along with other techniques/devices, such as water jacketed, air cooled, and/or cooled by a refrigerant, to bring the styrenic polymer latex down to a workable temperature before it enters optional Purification Stage 90.

In some embodiments, cleaning/purification of the styrenic polymers via such methods such as nitrogen stripping occurs before Cooling Stage 80. In some embodiments, purging by nitrogen is used to mitigate oxidation of the molten product material and the creation of explosive conditions.

Optional Purification Stage 90 involves the refinement and/or decontamination of the styrenic polymers. Techniques/devices that can used in Purification Stage 90 include, but are not limited to, flash separation, absorbent beds, clay polishing, distillation, vacuum distillation, and filtration to remove solvents, oils, color bodies, ash, inorganics, and coke. In some embodiments, a thin or wiped film evaporator is used to remove gas, oil and/or grease, and/or lower molecular weight functionalized polymers from the styrenic polymer latex. In some embodiments, the oil, gas, and lower molecular weight functionalized polymers can in turn be burned to help run various Stages of Process 1. In certain embodiments, the desired product can be isolated via separation or extraction and the solvent can be recycled.

Process 1 ends at Finished Product Stage 100 in which the initial starting material selected in Material Selection Stage 10 has been turned into styrenic polymers. In at least some embodiments, the styrenic polymers do not need additional processing and/or refining. In other embodiments, the styrenic polymers created at Finished Product Stage 100 need additional modifications.

The molecular weight, polydispersity, glass transition, melt flow, and olefin content that is generated via the depolymerization depends on the residence time of the polystyrene material within the reaction zone.

Styrenic polymers derived from depolymerized polystyrene have different properties compared to the starting plastic feedstock and traditional polystyrene plastics synthesised via polymerisation of styrene. For example, mid-molecular weight styrenic polymers produced via the depolymerization of polystyrene often contain specific structural or chemical properties, including but not limited to, olefin content or longer aliphatic sections near terminal positions of the chain. In addition, styrenic polymers produced via the depolymerization of polystyrene are often of a lower molecular weight.

In some embodiments, the finished product has an average molecular weight between 40000 amu and 200000 amu, a melt flow index equal to/greater than 0.5 g/10 min at 190° C. w/2.16 kg, and/or a glass transition temperature between 50° C. and 110° C. In some of these embodiments, the finished product has an average molecular weight between 55000 amu and 146000 amu, a melt flow index greater than 3.20 g/10 min at 190° C. w/2.16 kg, and/or a glass transition temperature between 75° C. and 105° C.

In some embodiments, the styrenic polymer has an average molecular weight between 20,000 amu and 200,000 amu, a melt flow between and inclusive of, 0 g/10 min and 100 g/10 min (determined via ASTM D1238). In some embodiments, the styrenic polymer has a glass transition temperature between 30° C.-115° C.

In some of embodiments, the styrenic polymer has an average molecular weight between 50,000-100,000, a melt flow index between 10 g/10 min to 200 g/10 min (determined via ASTM D1238).

In some embodiments, the generated depolymerization product material includes monomer (styrene), aromatic solvents including but not limited to toluene, cumene, ethyl benzene, alpha-methyl styrene, polyaromatic species, oils, and/or lower molecular weight functionalized polymers, such as those with increased olefin content.

In some embodiments the styrenic polymers can be further modified to add additional active sites such as carboxylic acids and amines. The active sites can serve functionalization purposes. In some embodiments, to improve compatibility and/or add function, various monomers and/or copolymers such as, but not limited to, acids, alcohols, acetates, acid anhydride, amines, and alkenes such as hexene, or maleic anhydride can be grafted onto the depolymerized product. Grafting can take place, among other places, in the reactor, in line with the stream after cooling, and/or in a separate vessel.

In some embodiments, the styrenic polymer comprises at least one olefin on the backbone of the chain, typically near a terminal position. In certain embodiments, the olefin content is less than 1% of the total weight of the styrenic polymer.

In at least some embodiments, the styrenic polymer(s) are soluble in organic mediums and/or aqueous formulations.

In some embodiments, it is desirable to convert the polymeric feed material into lower molecular weight polymers, with increased melt flow and olefin content. In some embodiments, the conversion is affected by heating the polystyrene feed material to generate molten polystyrene material, and then contacting the molten polystyrene material with a catalyst material within a reaction zone disposed at a temperature between 200° C. and 400° C., preferable between 275° C.-375° C. In some embodiments, a catalyst is not required.

The controlled depolymerization of polystyrene plastics can create styrenic polymers with lower molecular weights and greater polarity. The ability to tune the properties of the styrenic polymers derived from depolymerized polystyrene plastic allows styrenic polymer products to be designed specifically for uses. Use of styrenic polymers derived from waste polystyrene plastic can help reduce greenhouse gases, landfill waste, and the need for the production of new styrenic products derived from fossil or virgin polystyrene.

Styrenic polymers derived from depolymerized polystyrene can be used where traditional higher molecular weight polystyrene plastic cannot be used without modification. Such applications include, but are not limited to, inks, paints, coatings, adhesive formulations, and/or immunoassay tests.

In some embodiments, the generated depolymerization product material includes solvent or monomer (Styrene), polyaromatic solvents, oils and/or greases, and/or lower molecular weight functionalized polymer i.e., increased olefin content.

It is desirable to convert such polymeric feed material into lower molecular weight polymers, with increased melt flow and olefin content using an embodiment of the system disclosed herein. In each case, the conversion is affected by heating the polystyrene feed material so as to generate molten polystyrene material, and then contacting the molten polystyrene material with the catalyst material within a reaction zone disposed at a temperature of between 200° C. and 400° C., preferable 250-370° C. The molecular weight, polydispersity, glass transition, melt flow, and olefin content that is generated depends on the residence time of the molten polystyrene material within the reaction zone. When operating in a continuous system depending on the flowrate of the extruder or gear pump residence times vary from 5-180 minutes, preferably 20-90 minutes, with more than one reactor modules attached in series. In some of these embodiments, the supply and heating of the polystyrene feed material is affected by a combination of an extruder and a pump, wherein the material discharged from the extruder is supplied to the pump. In some of these embodiments, extruder 106 is a 10 HP, 1.5-inch (3.81 cm) Cincinnati Milacron Pedestal Extruder, Model Apex 1.5, and the pump 110 is sized at 1.5 HP for a 1.5-inch (3.81 cm) line.

### EXAMPLE 1

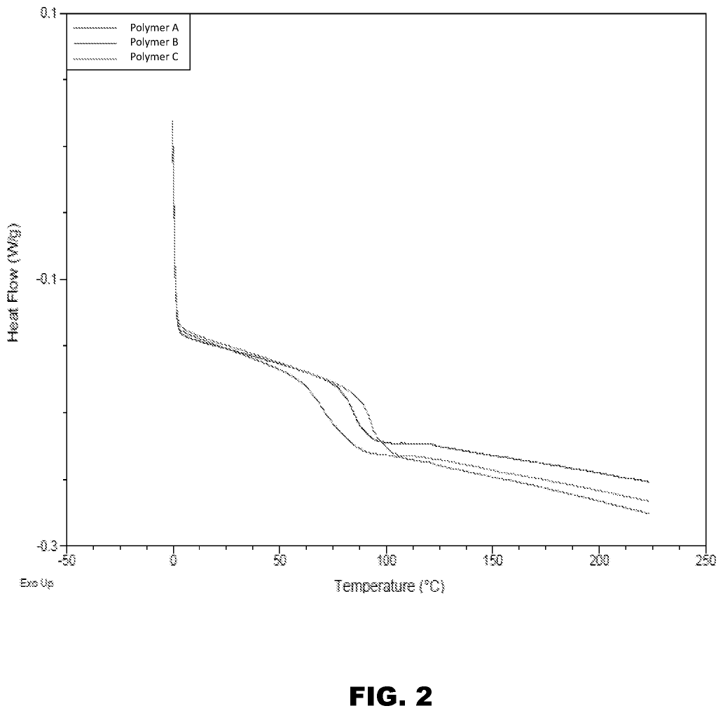

In an illustrative embodiment of the present process, four styrenic polymers formed via depolymerization of polystyrene were identified. (See Table 1). Polymer A through D were all made with a combination of post-consumer and/or post-industrial waste polystyrene. Polymer A & D (which had a low molecular weight); Polymer B (which had a mid-range molecular weight); and Polymer C (which had a high molecular weight). As a result of the varying molecular weight of the four polymers, the glass transition temperatures also varied. FIG. 2 shows an overlay of differential scanning calorimetry thermograms of polymers A-C showing variances in the glass transition temperatures.

TABLE 1
Styrenic Polymers

| | Polymer | Polymer | Polymer | Polymer |
|---|---|---|---|---|
| | A | B | C | D |
| MW | 56167 | 88901 | 104915 | 59255 |
| (Weight-average molecular weight as determined by gel | | | | |
| permeation chromatography) | | | | |
| MFI | >50 | 29.67 | 9.66 | >50 |
| (Melt Flow Index as determined by ASTM D1238) | | | | |
| Glass Transition Temperatureᵢₙᵢₜᵢₐₗ | 63.81 | 73.19 | 88.71 | 59.14 |
| (As determined by differential scanning calorimetry) | | | | |
| Glass Transition Temperature_{mid} | 80.91 | 85.18 | 95.34 | 76.01 |
| (As determined by differential scanning calorimetry) | | | | |
| Glass Transition Temperature_{end} | 97.78 | 97.17 | 101.79 | 92.66 |
| (As determined by differential scanning calorimetry) | | | | |

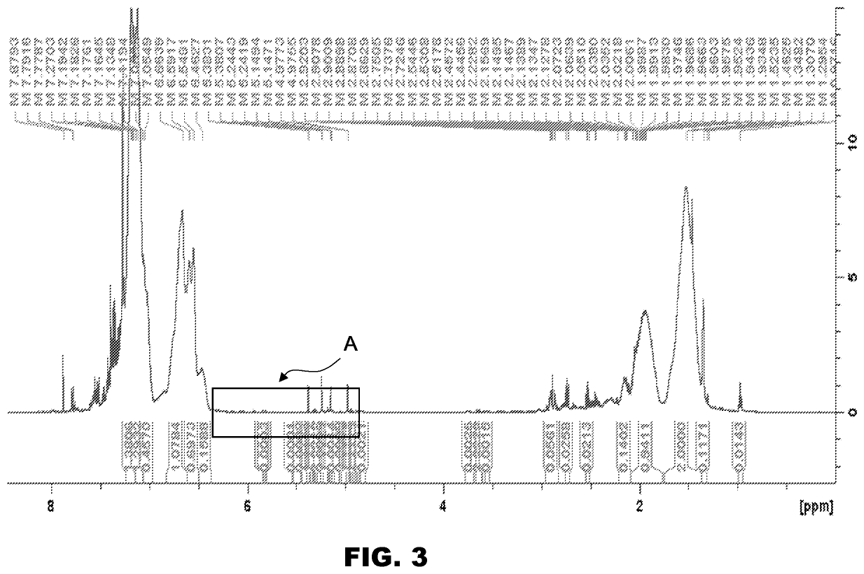

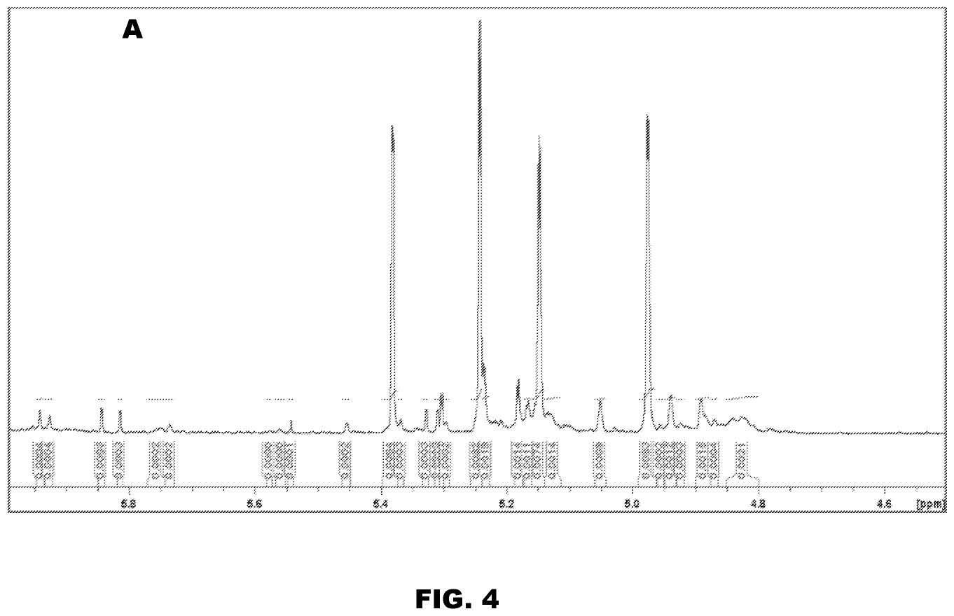

In some embodiments, the styrenic polymer(s) contain active sites (such as olefin moieties). These active sites are often a signature of materials produced via a depolymerization process. In some embodiments, the depolymerization process incorporates additional olefin content into the backbone of the polymer. Backbone or terminal olefins are identifiable features that are not present in styrenic polymer derived through polymerization methods. FIG. 3 and FIG. 4 show Nuclear Magnetic Resonance (NMR) Spectra of styrenic polymer material, supporting the presence of olefin species. Backbone or terminal olefins, which involve double bonded carbon atoms, are more polar in nature compared to polymers with saturated backbones. This makes polymers with olefin content more compatible in various organic and aqueous solvent formations than traditional polystyrene. In addition, the added olefin content can allow the styrenic polymer to act as a coupling agent with other multi-polymer systems.

In some embodiments, to improve compatibility and/or add function, the various monomers and/or copolymers are grafted on via the olefin fingerprint and/or aromatic functionality.

Polymer D has a viscosity between 10000-12000 cPs (determined via ASTM D1986.) A Brookfield viscosity measurement of polystyrene plastic is not possible due to the high molecular weight. The ability to now determine centipoise values using this method supports the reduction in molecular weight.

In some embodiments, the resulting styrenic polymer include greater than 20 ppm of iron; greater than 50 ppm of zinc; and/or greater than 20 ppm of titanium as determined by x-ray fluorescence. The presence of these metals confirms that the styrenic polymer was derived through either post-consumer or post-industrial waste polystyrene plastic. These metals also are now well dispersed in the styrenic polymer adding both polarity and reactivity. This can make the styrenic polymer more compatible in various organic and aqueous solvent formations than traditional polystyrene. In addition, the added metal content can allow the styrenic polymer to act as a coupling agent with other multi-polymer systems.

TABLE 2
X-Ray Fluorescence of Polymer D

| Metal | Concentration (ppm) |
|---|---|
| Ti | 29.26 |
| Zn | 158.47 |
| Fe | 29.73 |

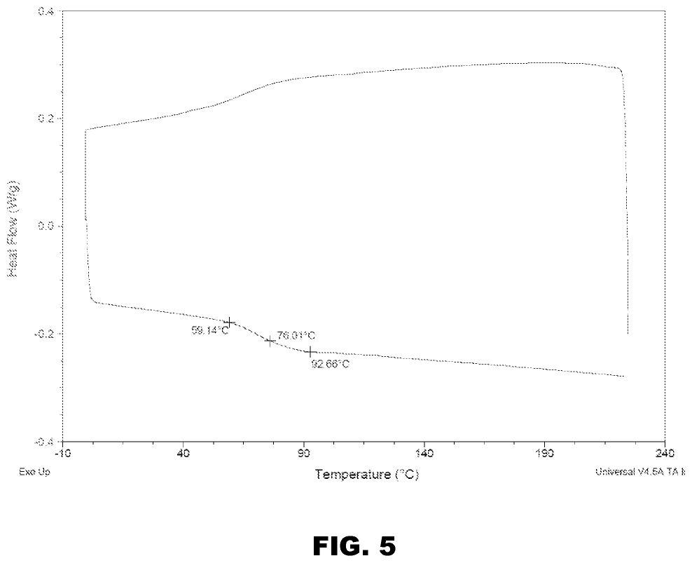

FIG. 5 is a Differential Scanning calorimetry thermogram for Polymer D (determined via ASTM D3418). As can be seen in FIG. 5, Polymer D has a glass transition temperature between 59.14° C. and 92.66° C.

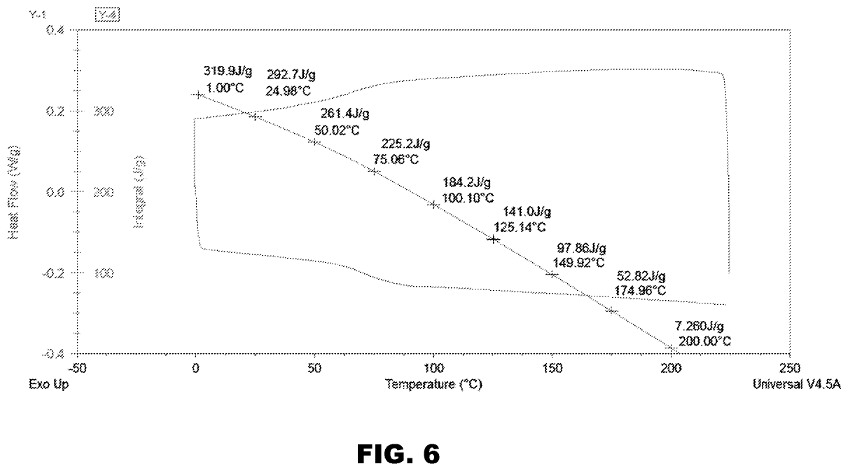

FIG. 6 is a Differential Scanning calorimetry thermogram of Polymer D showing the specific heat capacity and glass transition of the styrenic polymer. Supporting the reduction in glass transition temperature achieved as a direct result of the controlled depolymerization of polystyrene plastic.

TABLE 3
Specific Heat Capacity for Polymer D

| | Temperature | | | Specific Heat |
|---|---|---|---|---|
| Temperature | Difference | | J/g | Capacity |
| ° C. | ° C. | J/g | Difference | J/g · C. |
| 1.00 | | 319.9 | | |
| 24.98 | 23.98 | 292.7 | 27.2 | 1.134278565 |
| 50.02 | 25.04 | 261.4 | 31.3 | 1.25 |
| 75.06 | 25.04 | 225.2 | 36.2 | 1.445686901 |
| 100.10 | 25.04 | 184.2 | 41 | 1.637380192 |
| 125.14 | 25.04 | 141.0 | 43.2 | 1.725239617 |
| 149.92 | 24.78 | 97.86 | 43.14 | 1.740920097 |

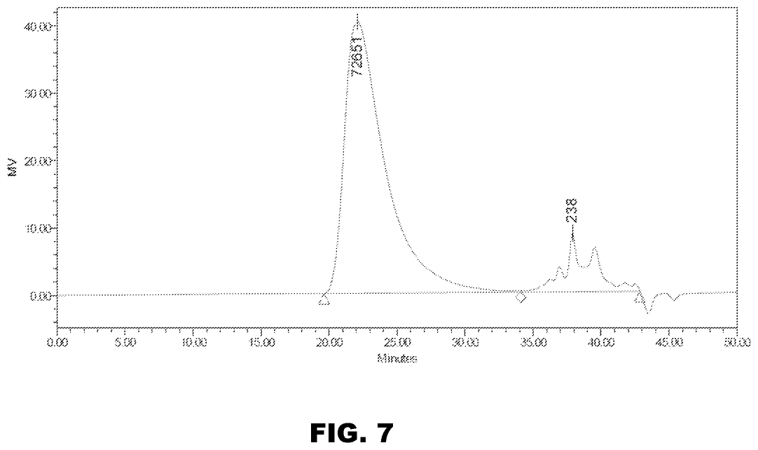

FIG. 7 is a gel permeation chromatography of Polymer D (determined via ASTM D6474-12) and provides the molecular weight of the styrenic polymer. FIG. 7 supports the reduction in molecular weight achieved as a direct result of the controlled depolymerization of polystyrene plastic.

TABLE 4
Gel Permeation Chromatography of Polymer D

| | | | | Mw/ | % below | % below |
|---|---|---|---|---|---|---|
| Mn | Mw | Mp | Mz | Mn | 500 Da | 1000 Da |
| 22553* | 59255 | 72561 | 97875 | 2.63 | 10.544 | 9.908 |

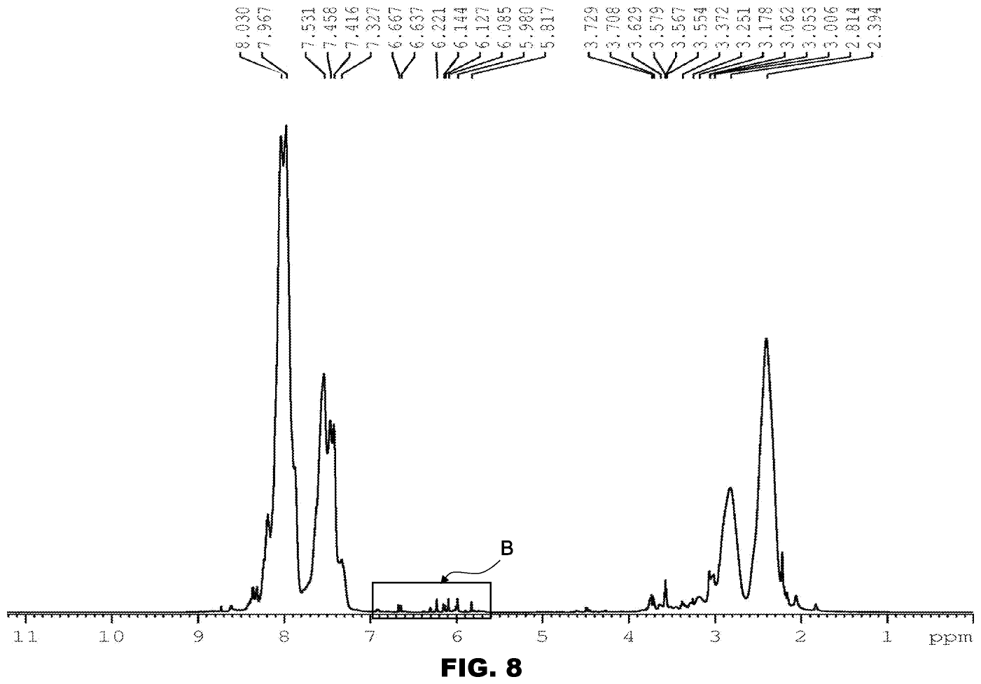

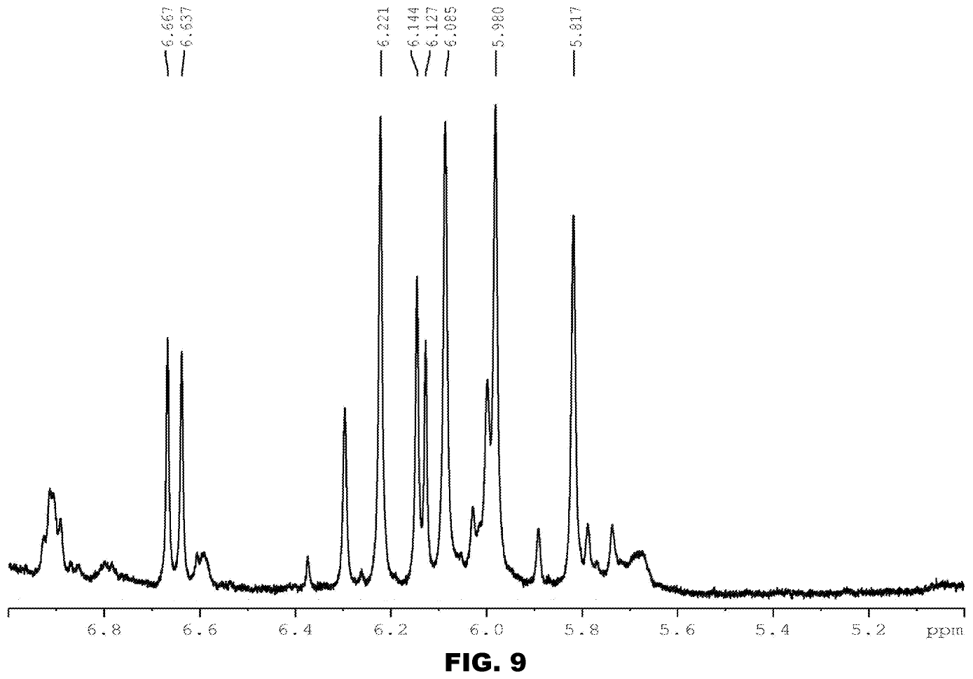

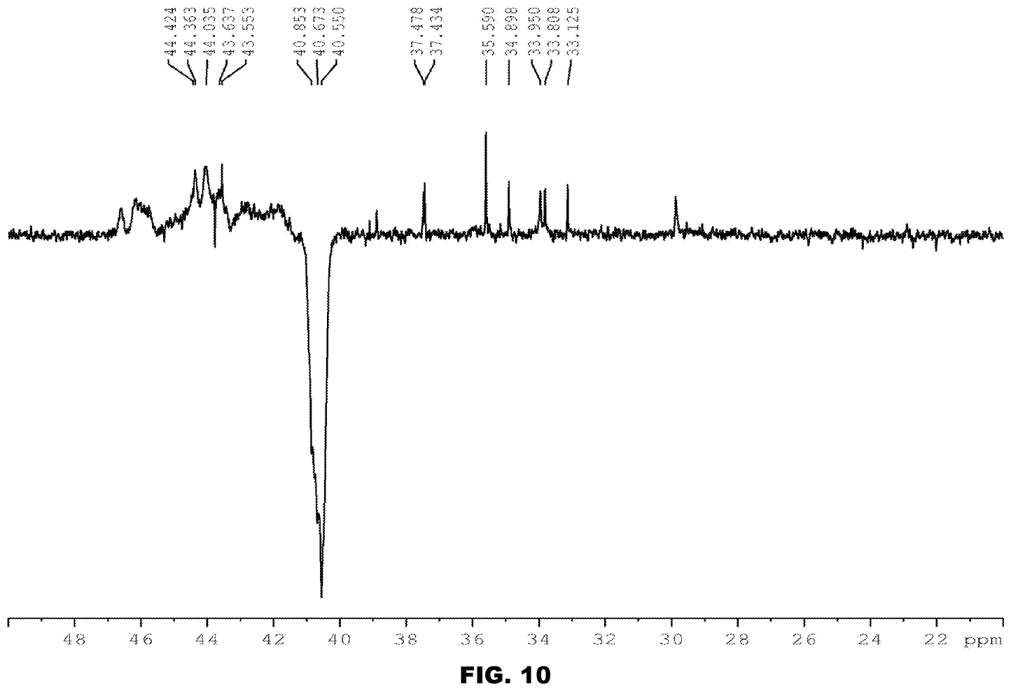

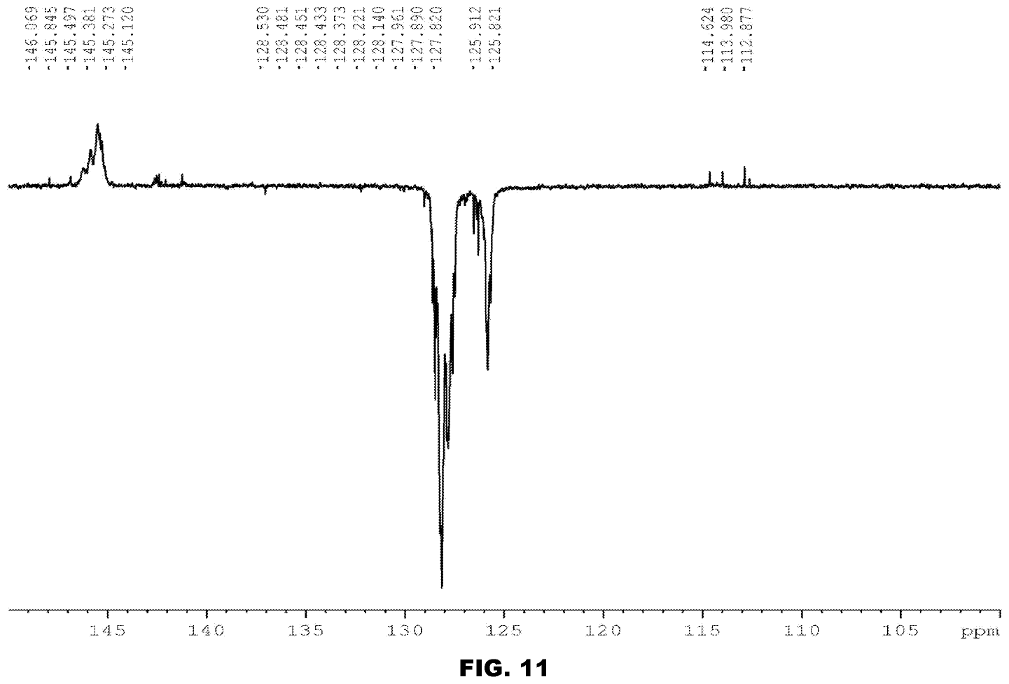

FIG. 8 to FIG. 11 show NMR Spectra of Polymer D, supporting the presence of olefin content on the backbone of the styrenic polymer product. This olefin content is a direct result of the controlled depolymerization of polystyrene plastic.

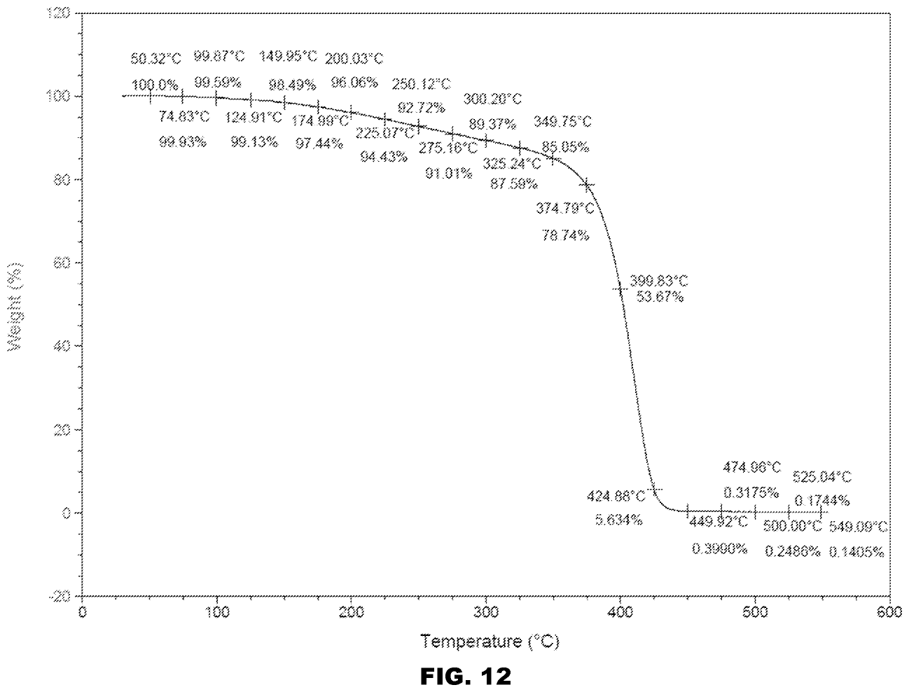

FIG. 12 is a Thermogravimetric Analysis of Polymer D (determined via ASTM E1131).

TABLE 5
Thermogravimetric Analysis of Polymer D

| Weight % | Weight % | Weight % | Weight % | Weight % |
|---|---|---|---|---|
| 100° C. | 175° C. | 200° C. | 300° C. | 400° C. |
| 99.59 | 97.44 | 96.06 | 89.37 | 53.67 |

While particular elements, embodiments and applications of the present invention have been shown and described, it will be understood, that the invention is not limited thereto since modifications can be made without departing from the scope of the present disclosure, particularly in light of the foregoing teachings. For example, the numerous embodiments demonstrate that different combinations of components are possible within the scope of the claimed invention, and these described embodiments are demonstrative and other combinations of the same or similar components can be employed to achieve substantially the same result in substantially the same way. Further, all of the claims are hereby incorporated by reference into the description of the preferred embodiments.

What is claimed is:

1. A composition comprising:
(a) at least about 75% by weight of a styrenic polymer with molecular weight between 1,000-200,000 amu wherein said styrenic polymer was derived from depolymerization of a polystyrene feedstock.

2. The composition of claim 1 wherein said depolymerization of said polystyrene feedstock is at least partially catalytic.

3. The composition of claim 1 wherein said depolymerization of said polystyrene feedstock is at least partially thermal.

4. The composition of claim 1, wherein said polystyrene feedstock comprises post-consumer recycle derived reclaimed polystyrene.

5. The composition of claim 1 wherein the polystyrene feedstock comprises post-industrial recycle derived reclaimed polystyrene.

6. The composition of claim 1 wherein said styrenic polymer comprises between 0.1-5% olefin content on the backbone of the chain.

7. The composition of claim 1 wherein said styrenic polymer comprises greater than 50 ppm of zinc.

8. The composition of claim 1 wherein said styrenic polymer comprises greater than 20 ppm titanium.

9. The composition of claim 1 wherein said styrenic polymer comprises greater than 20 ppm iron.

10. The composition of claim 1 wherein said styrenic polymer comprises:
(i) greater than 20 ppm iron; and/or
(ii) greater than 50 ppm of zinc; and/or
(iii) greater than 20 ppm titanium.

11. The composition of claim 1 wherein said styrenic polymer has an average molecular weight between 10,000 amu and 150,000 amu and a glass transition temperature between 59° C. and 92° C.

12. The composition of claim 1 wherein said styrenic polymer comprises a grafted acid, such as maleic anhydride.

13. The composition of claim 1 wherein said composition is soluble in organic mediums and/or aqueous formulations.

14. The composition of claim 1, wherein said polystyrene feedstock comprises greater than 5% of post-consumer recycle derived reclaimed polystyrene.

15. The composition of claim 1, wherein said polystyrene feedstock comprises up to 25% of material that is other than polystyrene material, based on the total weight of said polystyrene feedstock.

16. A composition comprising:
(a) at least about 75% by weight of a styrenic polymer with molecular weight between 1,000-200,000 amu wherein said styrenic polymer was derived from a catalytic depolymerization of a polystyrene feedstock,
wherein said polystyrene feedstock comprises greater than 5% post-consumer recycle derived reclaimed polystyrene,
wherein said styrenic polymer comprises between 0.1-5% olefin content on the backbone of the chain,
wherein said styrenic polymer comprises greater than 50 ppm of zinc,
wherein said styrenic polymer comprises greater than 20 ppm titanium, and
wherein said styrenic polymer comprises greater than 20 ppm iron.

17. The composition of claim 16 wherein said styrenic polymer comprises a grafted acid, such as maleic anhydride.

18. The composition of claim 16 wherein said composition is soluble in organic mediums and/or aqueous formulations.

19. The composition of claim 16 wherein said polystyrene feedstock comprises up to 25% of material that is other than polystyrene material, based on the total weight of said polystyrene feedstock.
